(19) United States
(12) Patent Application Publication
(10) Pub. No.: US 2017/0338555 A1
(43) Pub. Date: Nov. 23, 2017

(54) PARASITIC ELEMENT CONTROL METHOD AND APPARATUS FOR SINGLE RADIO FREQUENCY (RF) CHAIN-BASED ANTENNA ARRAY

(71) Applicant: ELECTRONICS AND TELECOMMUNICATIONS RESEARCH INSTITUTE, Daejeon (KR)

(72) Inventors: Yong Ho LEE, Daejeon (KR); Jung Hoon OH, Daejeon (KR); Jung Nam LEE, Daejeon (KR)

(21) Appl. No.: 15/593,454

(22) Filed: May 12, 2017

(30) Foreign Application Priority Data
May 17, 2016 (KR) 10-2016-0060067

(51) Int. Cl. H01Q 3/01; H01Q 3/34; H01Q 3/24; H01Q 21/22; H01Q 5/385

(52) U.S. Cl. CPC H01Q 3/01; H01Q 21/22; H01Q 5/385; H01Q 3/24; H01Q 3/34

(57) ABSTRACT

Parasitic element control apparatus and method for a single radio frequency (RF) chain-based antenna array. The apparatus includes an arranger configured to arrange antenna elements, each including a single active element and a plurality of parasitic elements, and generate an antenna structure, a designer configured to design a control parameter for controlling the parasitic elements based on the antenna structure, and an adjuster configured to adjust the parasitic elements based on the control parameter.

### CROSS-REFERENCE TO RELATED APPLICATION(S)

This application claims the priority benefit of Korean Patent Application No. 10-2016-0060067, filed on May 17, 2016 in the Korean Intellectual Property Office, the disclosure of which is incorporated herein by reference for all purposes.

### BACKGROUND

### 1. Field

One or more example embodiments relate to parasitic element control method and apparatus for a single radio frequency (RF) chain-based antenna array.

### 2. Description of Related Art

Research and development on application technology for various communication systems using have been carried out using an antenna arrangement gain of a multi-antenna array. A system using the multi-antenna array may operate based on various arrangement gains. However, in the system using the multi-antenna array, system efficiency may be reduced due to power consumption for operating a multi-RF chain corresponding to a number of antenna array elements. For this reason, technology for acquiring an arrangement gain of the multi-antenna array using a single RF chain-based antenna array has been required.

In terms of the single RF chain-based antenna array, a degree of freedom may be restricted due to a structural characteristic of the single RF chain-based antenna array when compared to the multi-antenna array. To solve this, a parasitic element of an antenna array may be controlled to acquire an arrangement gain higher than that of a single element antenna. To acquire the arrangement gain, a control parameter of a parasitic element satisfying requirements of technology may be designed and the parasitic element may be controlled based on the designed control parameter.

In related arts, there has been developed various control parameter designing schemes for such achievement. However, technology for designing a control parameter in consideration of an antenna or RF performance may be still insufficient in practice. This is because design and implementation difficulties significantly vary depending on the technology for designing a control parameter in consideration of an antenna or RF performance and an element control scheme.

Accordingly, there is desire for technology to easily implement a control parameter in consideration of an antenna or RF performance and control or arrange parasitic elements.

### SUMMARY

An aspect provides parasitic element control method and apparatus for a single radio frequency (RF) chain-based antenna array to design a control parameter based on an antenna or RF performance, arrange parasitic elements at an optimal position, and adjust an arranged position, thereby preventing degradation in performance.

Another aspect also provides parasitic element control method and apparatus for a single RF chain-based antenna array to additionally perform an antenna or RF performance-based design process without need to correct a preset parameter design process.

According to an aspect, there is provided a parasitic element control apparatus for a single RF chain-based antenna array, the apparatus including an arranger configured to arrange antenna elements, each including a single active element and a plurality of parasitic elements, and generate an antenna structure, a designer configured to design a control parameter for controlling the parasitic elements based on the antenna structure, and an adjuster configured to adjust the parasitic elements based on the control parameter.

According to another aspect, there is also provided a method of controlling a parasitic element for a single RF chain-based antenna array, the method including arranging antenna elements, each including a single active element and a plurality of parasitic elements, and generating an antenna structure, designing a control parameter for controlling the parasitic elements based on the antenna structure, and adjusting the parasitic elements based on the control parameter.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a parasitic element control apparatus for a single radio frequency (RF) chain-based antenna array according to an example embodiment;

FIGS. 2A through 2C are diagrams illustrating various integrated configurations of a control parameter design operation based on an antenna or RF performance and a general design operation according to an example embodiment;

FIG. 3 is a diagram illustrating influence relationships between elements of a 5-element electronically steerable parasitic array radiator (ESPAR) antenna according to an example embodiment;

FIGS. 4A through 4C are diagrams illustrating examples of arranging parasitic elements according to an example embodiment; and

FIG. 5 is a flowchart illustrating a parasitic element control method for a single RF chain-based antenna array according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

In this disclosure, parasitic element control apparatus and method for a single radio frequency (RF) chain-based antenna array may design a control parameter based on an antenna and RF performance, arrange an active element and parasitic elements at optimal positions, and control the active element and the parasitic elements, thereby prevent degradation in performance.

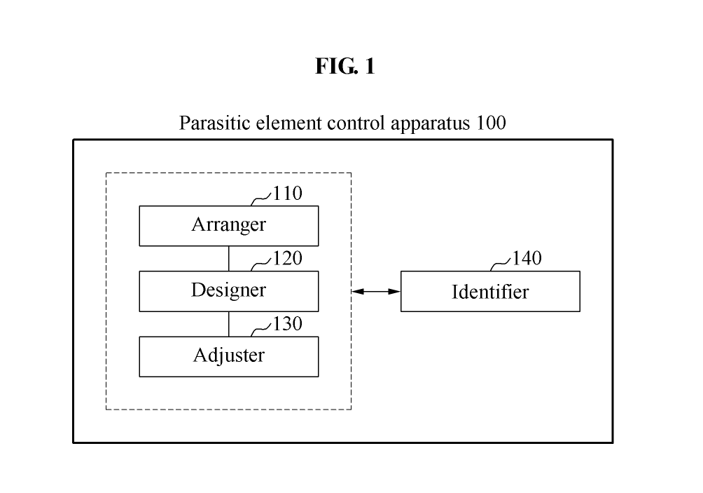

FIG. 1 is a block diagram illustrating a parasitic element control apparatus for a single RF chain-based antenna array according to an example embodiment.

A parasitic element control apparatus 100 for a single RF chain-based antenna array may include an arranger 110, a designer 120, and an adjuster 130. The parasitic element control apparatus 100 may further include an identifier 140 depending on examples.

In this disclosure, an antenna may be, but not limited to, an electronically steerable parasitic array radiator (ESPAR) antenna. The ESPAR antenna may be based on a single RF chain, and may include a single active element and a plurality of parasitic elements.

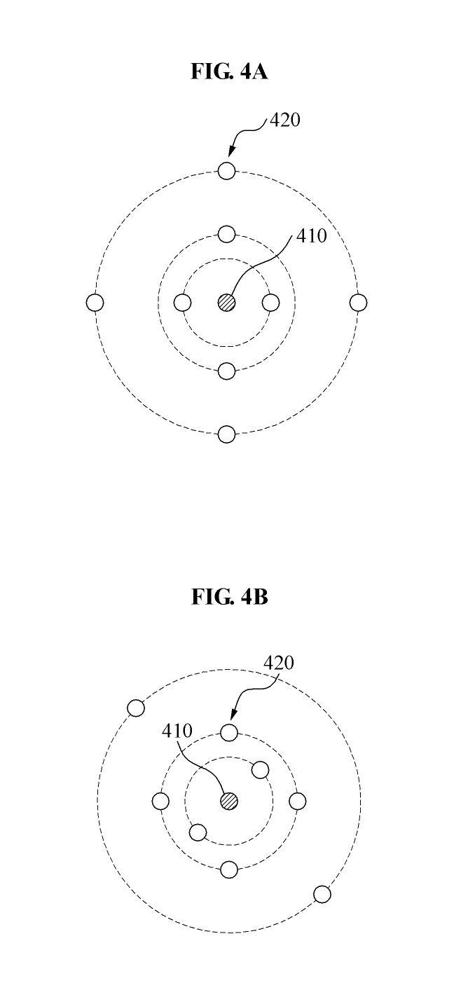

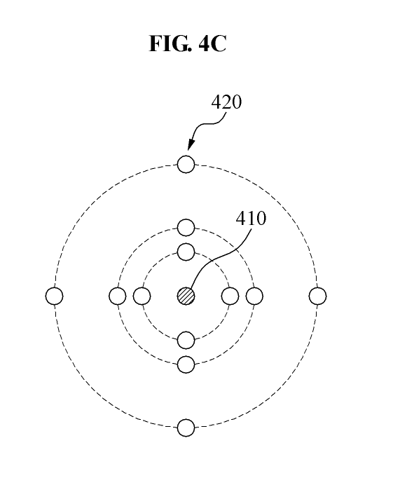

The arranger 110 may generate an antenna structure by arranging antenna elements, each including a single active element and a plurality of parasitic elements. The arranger 110 may arrange the active element and the parasitic elements based on a rule of series. For example, the arranger 110 may arrange the parasitic elements around the active element to prevent the degradation in performance. In this example, a number of parasitic elements may be an even number. Also, the rule of series may be described with reference to FIG. 4.

Also, when arranging the parasitic elements, the arranger 110 may symmetrically arrange a predetermined pair of parasitic elements based on the active element. For example, the arranger 110 may arrange an even number of parasitic elements so as to be symmetric vertically, horizontally or hexagonally.

The designer 120 may design a control parameter for controlling the parasitic elements based on the antenna structure. For example, the designer 120 may design a control parameter associated with a control of at least one parasitic element. The designer 120 may design a control parameter associated with a parasitic parameter for acquiring an arrangement gain in the single RF chain-based ESPAR antenna.

Also, when a radiation pattern of each of the antenna elements is identified, the designer 120 may design the control parameter based on the identified radiation pattern. That is, to apply the antenna and RF performance, the designer 120 may identify the radiation pattern of each of the antenna elements and design a control parameter associated with an arranged position of the parasitic elements based on the radiation pattern.

The designer 120 may design a control parameter of the parasitic elements arranged in a separation range from the active element in which a mutual coupling occurs. For example, the designer 120 may design the control parameter of the parasitic elements such that an induced current due to the mutual coupling with the active element is adjusted. In this example, the designer 120 may design the control parameter such that the induced current flowing in the parasitic elements varies based on the arranged position of the parasitic elements.

The designer 120 may evaluate a performance for an impedance load occurring in the parasitic element, extract an optimal combination of impedance load satisfying a reference, and design the control parameter by incorporating information on the extracted optimal combination. For example, the designer 120 may evaluate the performance using an algorithm for each impedance load combination and extract at least one optimal combination satisfying the reference from all impedance load combinations.

The designer 120 may set a phase or an absolute value based on the impedance load as the reference when the control parameter is designed to be associated with a multiplexing gain. The designer 120 may set at least one of a back-lobe, a beam width, a beam gain, and a beamforming direction based on the impedance load as the reference when the control parameter is designed to be associated with beamforming. For example, when designing the control parameter for the multiplexing gain, the designer 120 may set a phase, an absolute value, and the like of a weight corresponding to a basis function to be the reference and extract an optimal combination. Also, when designing the control parameter for the beamforming, the designer 120 may extract the optimal combination based on the beamforming direction.

With respect to the antenna or the single RF chain, the designer 120 may evaluate a performance associated with, for example, a voltage standing wave ratio (VSWR), a return loss, a reflection coefficient, a radiation efficiency, a beam-width, and a directivity gain. In this example, the designer 120 may evaluate a single performance or a plurality of performances with respect to the antenna or the single RF chain simultaneously.

The adjuster 130 may adjust the parasitic element based on the control parameter. The adjuster 130 may change a combination corresponding to the parasitic elements. For example, the adjuster 130 may control two parasitic elements facing each other based on the active element.

When the control parameter is associated with a change in arranged position, the adjuster 130 may adjust the parasitic elements by switching the two parasitic elements facing each other based on the active element. For example, the adjuster 130 may count the facing parasitic elements as a single group. In this example, for

$$\frac{N - 1}{2}$$

groups, the adjuster 130 may perform control by switching two load combinations to each other. Since the VSWR of the active element is not affected, the adjuster 130 may perform dynamic matching without a separate dynamic matching circuit and perform independent group-to-group switching.

Also, when a parasitic element is added to the antenna structure, the adjuster 130 may adjust the parasitic elements by determining a position at which the parasitic element is to be disposed or changing an arranged position of one of the parasitic elements included in the antenna structure based on the control parameter. That is, the adjuster 130 may perform adjustment by determining a position of a new parasitic element or changing a position of a parasitic element that has been arranged, based on the antenna structure.

The identifier 140 may identify the radiation pattern of the antenna element by adding a beam pattern formed by a current flowing in the active element and a beam pattern formed by an induced current flowing in the parasitic element. In this example, the identifier 140 may obtain a vector i of a current flowing in an antenna based on a voltage-current relationship according to Equation 1.

i=vₛ(Z+X)⁻¹u, where i=[i₀ i₁ . . . i_{N-1}]^{T} [Equation 1]
Z: impedance matrix
X: load matrix
u: unit vector

Also, the identifier 140 may identify the radiation pattern based on a sum of individual patterns Pₙ(φ,θ) radiated by the antenna elements according to Equation 2.

$${P}_{total} ( φ , θ ) = {\sum }_{n = 0}^{N - 1} {P}_{n} ( φ , θ ) \qquad [ Equation 2 ]$$

The adjuster 130 may adjust the parasitic elements based on the identified radiation pattern. That is, the adjuster 130 may adjusts the parasitic elements based on the radiation pattern of each of the antenna elements. For example, the adjuster 130 may adjust a predetermined parasitic element such that an arranged position of the parasitic element is changed to be farther from or closet to the active element. Through this, the adjuster 130 may allow radiation patterns of a pair of the adjusted parasitic element and another parasitic element to achieve a similarity within an allowable range.

The identifier 140 may identify the radiation pattern of each of the antenna elements by applying a current flowing in the antenna element to a unique beam pattern of the antenna element as a weight. For example, in terms of a lineal antenna array, the identifier 140 may identify a radiation pattern modeled using an array factor. In this example, the identifier 140 may identify a radiation pattern of an ESPAR antenna using a sum of radiation patterns formed by induced currents of parasitic elements due to an impedance load and mutual coupling and a radiation pattern formed by a current flowing in an active element. That is, the identifier 140 may identify a reformed radiation pattern of the ESPAR antenna by adjusting the induced currents of the parasitic elements using an electric signal.

As such, the parasitic element control apparatus 100 may design a control parameter based on an antenna or RF performance, arrange parasitic elements at an optimal position, and adjust an arranged position, thereby preventing degradation in performance.

Also, the parasitic element control apparatus 100 may additionally perform an antenna or RF performance-based design process without need to correct a preset parameter design process.

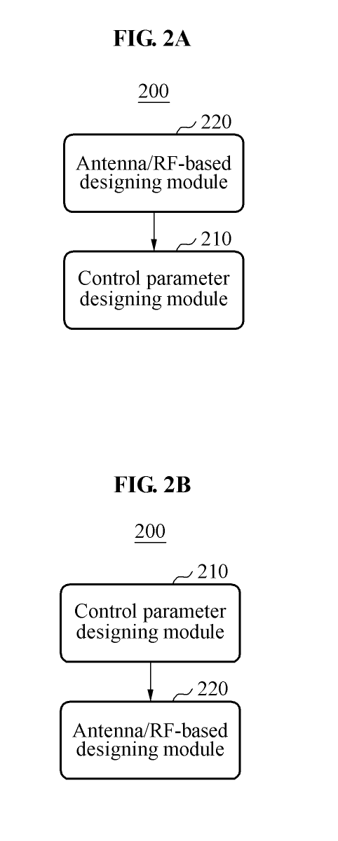

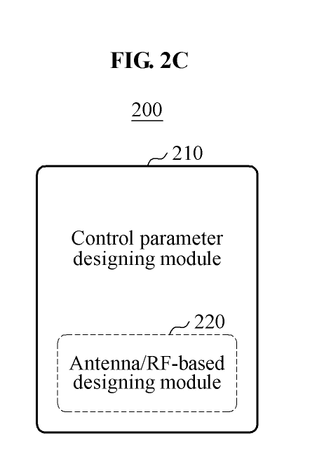

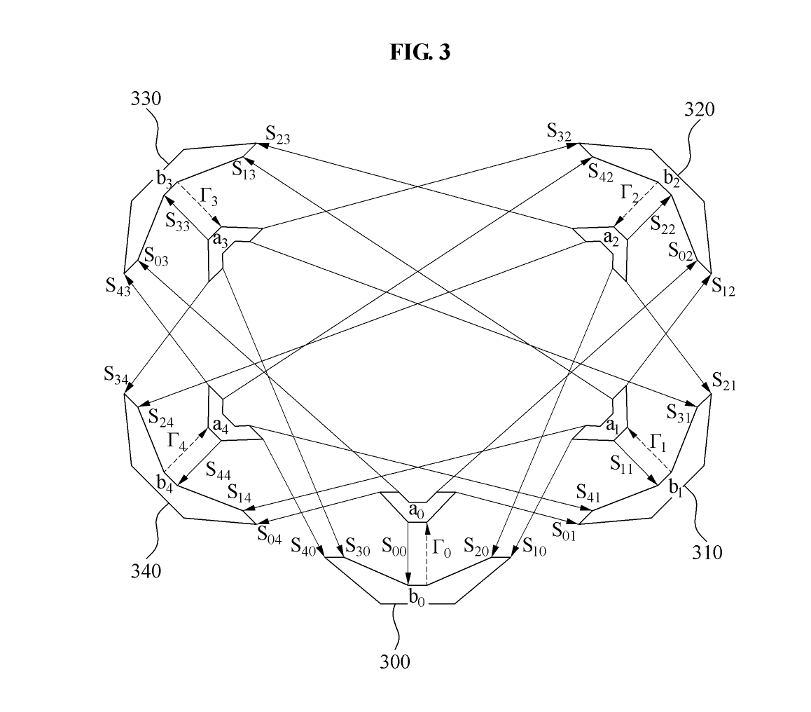

FIGS. 2A through 2C are diagrams illustrating various integrated configurations of a control parameter design operation based on an antenna or RF performance and a general design operation according to an example embodiment.

A parasitic element control apparatus 200 may include a control parameter designing module 210 and an antenna/RF-based designing module 220.

In a process of designing a control parameter of a parasitic element, the parasitic element control apparatus 200 may design the control parameter based on an antenna or RF performance using the antenna/RF-based designing module 220. In an example of FIG. 2A, the parasitic element control apparatus 200 may operate the antenna/RF-based designing module 220, and then design the control parameter using the control parameter designing module 210. In an example of FIG. 2B, the parasitic element control apparatus 200 may design the control parameter using the control parameter designing module 210 and operate the antenna/RF-based designing module 220. In an example of FIG. 2C, the parasitic element control apparatus 200 may operate the antenna/RF-based designing module 220 in a process of designing the control parameter using the control parameter designing module 210.

As such, based on various ordinal arrangements, the parasitic element control apparatus 200 may design the control parameter in consideration of the antenna or RF performance and maintain a control parameter design frame, thereby reducing a difficulty in designing the control parameter. Also, the parasitic element control apparatus 200 may more intuitively perform design and analysis on a control parameter of an antenna array including a plurality of parasitic elements.

In the following description, an antenna may be, for example, a single RF chain-based ESPAR antenna. However, a type of antenna is not limited thereto.

In general, the single RF chain-based ESPAR antenna, hereinafter, referred to as “an ESPAR antenna, may include a single active antenna and a plurality of parasitic elements. The parasitic element control apparatus 200 may arrange the parasitic elements in a predetermined range from the active element such that the active element is mutually coupled with the parasitic elements.

The foregoing example may be for applying a mutual coupling between the active element and the parasitic element, that is, an operating principle of the ESPAR antenna. In this example, in the active element arranged by the parasitic element control apparatus 200, a current may be generated by an RF chain or module connected to an antenna main port. In the parasitic elements arranged by the parasitic element control apparatus 200, different induced current may flow due to the mutual coupling based on an impedance load value. For example, even though the same current is generated in the two active elements of the ESPAR having the same number of elements, different currents may be induced to parasitic elements based on an overall antenna structure, a form of the parasitic element, and an impedance load.

The parasitic element control apparatus 200 may control the impedance load of the parasitic element using an electric signal based on such characteristic to adjust the induced current of the parasitic element. The parasitic element control apparatus 200 may model a current vector flowing in the ESPAR antenna using Equation 1. Also, the parasitic element control apparatus 200 may perform approximate modeling using a sum of individual patterns radiated by antenna elements based on an antenna array pattern modeling scheme which is used widely. The parasitic element control apparatus 200 may verify a sum of patterns using Equation 2.

The parasitic element control apparatus 200 may model the radiation pattern of each of the antenna elements by applying a current flowing in the corresponding element to a unique beam pattern thereof. For example, in terms of a linear antenna array, the parasitic element control apparatus 200 may perform pattern modeling based on an arrangement coefficient. Through such weight-based modeling, the parasitic element control apparatus 200 may approximately model a radiation pattern of the ESPAR antenna based on a sum of a radiation pattern formed by a current flowing in the active element and radiation patterns formed by induced currents of the parasitic elements based on the mutual coupling and the impedance load. The parasitic element control apparatus 200 may adjust the induced current of the parasitic element using the electric signal such that the radiation pattern of the ESPAR antenna is reformed. Such radiation pattern reforming process of the parasitic element control apparatus 200 may be applicable to research, for example, a single RF chain-based multiplexing gain and beamforming.

In terms of a general control parameter designing process for the multiplexing gain or the beamforming, the parasitic element control apparatus 200 may evaluate performances using an algorithm with respect to all possible impedance load combinations, extract optimal load combinations satisfying a reference, and control the optimal load combinations. In this example, a reference for the multiplexing gain may be, for example, a phase and an absolute value of a weight corresponding to a basis function. Also, a reference for the beamforming may be, for example, a beamforming direction.

Although the optimal load combinations are obtained based on a series of algorithms, some of the combinations may cause degradation in performance or may be unrealizable in an actual process of configuring an antenna or RF. The parasitic element control apparatus 200 may avoid the degradation in performance further based on the antenna or RF performance.

The parasitic element control apparatus 200 may consider a VSWR, a return loss, a reflection coefficient, a radiation efficiency, a beam-width, and a directivity gain. Also, the parasitic element control apparatus 200 may consider a single performance or a plurality of performances simultaneously.

FIG. 3 is a diagram illustrating influence relationships between elements of a 5-element ESPAR antenna according to an example embodiment.

Referring to FIG. 3, the parasitic element control apparatus 200 may use 5-element ESPAR antennas 300, 310, 320, 330, and 340 to evaluate performances of a VSWR and a return coefficient and select load combinations satisfying a predetermined reference. The parasitic element control apparatus 200 may input the selected load combinations to a control parameter designing module and extract optimal load combinations. The reference may vary based on requirements of a designer and a system.

When an antenna/RF-based designing operation is performed prior to a control parameter designing operation as described with reference to FIG. 2B, the parasitic element control apparatus 200 may evaluate a performance such as the VSWR, the return coefficient, and the like with respect to output load combinations of the control parameter designing module 210 and re-derive optimal load combinations.

FIGS. 4A through 4C are diagrams illustrating examples of arranging parasitic elements according to an example embodiment.

In general, an N-element ESPAR antenna may include an even number of parasitic elements 420. As illustrated in FIGS. 4A through 4C, the parasitic element control apparatus 200 may arrange the even number of parasitic elements 420 around an active element 410 in various forms in consideration of mutual coupling. The parasitic element control apparatus 200 may symmetrically arrange the parasitic elements 420 such that a pair of parasitic elements 420 faces each other.

When the parasitic elements 420 are controlled to acquire an arrangement gain, an antenna or RF performance such as a VSWR of the active element 410 may be significantly changed based on a control parameter. In this example, a control parameter restricted to be less than an allowable value may be used or a dynamic matching may be performed, which may increase an implementation complexity. The more various control parameters are used, the greater a necessity of the dynamic matching. Thus, the parasitic element control apparatus 200 may avoid the dynamic matching by applying a parasitic element arrangement and control condition.

The rule of series, which is discussed with respect to the arranger 110 of FIG. 1, is described as follows.

The parasitic element control apparatus 200 may arrange an even number of parasitic elements in a vertically and horizontally symmetric form with respect to an arrangement and the number of parasitic elements as the parasitic element arrangement and control condition. When implementing a load for each parasitic element, the parasitic element control apparatus 200 may implement up to two loads, for example, implement the same load for elements facing each other. When controlling the parasitic elements, the parasitic element control apparatus 200 may perform a switching control on the facing elements. In terms of the number of different load combinations of an antenna array, the parasitic element control apparatus 200 may arrange up to

$$\frac{N - 1}{2}$$

loads.

When two parasitic elements facing each other are defined as a single group, the parasitic element control apparatus 200 may generate

$$\frac{N - 1}{2}$$

groups. The parasitic element control apparatus 200 may allow the generated groups to be switched to each other based on a combination of two loads such that a separate dynamic matching circuit is not required. Also, since the VSWR of the active element is not affected, the parasitic element control apparatus 200 may allow a group-to-group switching control to be performed independently.

As such, the arranger 110 may arrange the parasitic elements based on the rule of series.

Also, when designing a control parameter for the N-element antenna array, the parasitic element control apparatus 200 may obtain N-dimensional data for a single observation performance. In this example, as the number of elements in the antenna array increases, data dimension may also increase. For this reason, it may be difficult to determine an optimal load combination and analyze a tendency based on a load combination. Thus, the parasitic element control apparatus 200 may structure a parameter such that all groups use the same load combination. For example, the parasitic element control apparatus 200 may allow all of the groups to use the same load combination based on an independent characteristic of the switching control. Also, the parasitic element control apparatus 200 may reduce the data dimension to be three dimensions or four dimensions to enable intuitive analysis and design. Through this, the parasitic element control apparatus 200 may intuitively acquire a tendency and analyze an optimal load combination based on a performance of a power ratio between basis functions.

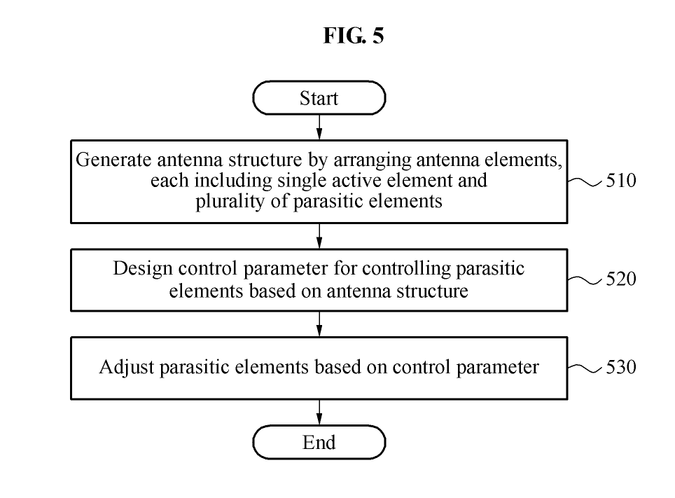

FIG. 5 is a flowchart illustrating a parasitic element control method for a single RF chain-based antenna array according to an example embodiment.

The parasitic element control method may be performed by the parasitic element control apparatus 100.

In operation 510, the parasitic element control apparatus 100 may generate an antenna structure by arranging antenna elements, each including a single active element and a plurality of parasitic elements. Operation 510 may be, for example, an operation of arranging the parasitic elements around the active element based on a rule of series. In this example, a number of parasitic elements may be an even number.

Also, operation 510 may be an operation of arranging the parasitic elements by symmetrically arranging a predetermined pair of parasitic elements based on the active element. For example, the parasitic element control apparatus 100 may arrange an even number of parasitic elements to be symmetric vertically, horizontally or hexagonally. In this example, the parasitic element control apparatus 100 may arrange the parasitic elements at positions designated by the rule of series.

Also, when arranging the parasitic elements in operation 510, parasitic elements facing based on the active element may be switched to each other to change the arranged position. For example, the parasitic element control apparatus 100 may count the facing parasitic elements as a single group. In this example, for

$$\frac{N - 1}{2}$$

groups, the parasitic element control apparatus 100 may perform control by switching two load combinations to each other. Since the VSWR of the active element is not affected, the parasitic element control apparatus 100 may perform dynamic matching without a separate dynamic matching circuit and perform independent group-to-group switching.

In operation 520, the parasitic element control apparatus 100 may design a control parameter for controlling the parasitic elements based on the antenna structure. For example, in operation 520, the parasitic element control apparatus 100 may design an arranged position of an antenna element including a single active element and a plurality of parasitic elements based on the rule of series. Also, the parasitic element control apparatus 100 may design a control parameter associated with a parasitic element for acquiring an arrangement gain in a single RF chain-based ESPAR antenna in operation 520.

Prior to the designing of the control parameter, when a radiation pattern of each of the antenna elements is identified, the parasitic element control apparatus 100 may design the control parameter based on the identified radiation pattern. That is, to apply the antenna and RF performance, the parasitic element control apparatus 100 may identify the radiation pattern of each of the antenna elements and design a control parameter associated with an arranged position of the parasitic elements based on the radiation pattern.

In operation 520, the parasitic element control apparatus 100 may design a control parameter of the parasitic elements arranged in a separation range from the active element in which a mutual coupling occurs. For example, the parasitic element control apparatus 100 may design the control parameter of the parasitic elements such that an induced current due to the mutual coupling with the active element is adjusted. In this example, the parasitic element control apparatus 100 may design the control parameter such that the induced current flowing in the parasitic elements varies based on the arranged position of the parasitic elements.

In operation 520, the parasitic element control apparatus 100 may evaluate a performance for an impedance load occurring in the parasitic element, extract an optimal combination of impedance load satisfying a reference, and design the control parameter by incorporating information on the extracted optimal combination. For example, the parasitic element control apparatus 100 may evaluate the performance using an algorithm for each impedance load combination and extract at least one optimal combination satisfying the reference from all impedance load combinations.

Also, in operation 520, the parasitic element control apparatus 100 may set a phase or an absolute value based on the impedance load as the reference when the control parameter is designed to be associated with a multiplexing gain, and may set at least one of a back-lobe, a beam width, a beam gain, and a beamforming direction based on the impedance load as the reference when the control parameter is designed to be associated with beamforming. For example, when designing the control parameter for the multiplexing gain, the parasitic element control apparatus 100 may set a phase, an absolute value, and the like of a weight corresponding to a basis function to be the reference and extract an optimal combination. Also, when designing the control parameter for the beamforming, the parasitic element control apparatus 100 may extract the optimal combination based on the beamforming direction.

With respect to the antenna or the single RF chain, the parasitic element control apparatus 100 may evaluate a performance associated with, for example, a VSWR, a return loss, a reflection coefficient, a radiation efficiency, a beam-width, and a directivity gain. In this example, the parasitic element control apparatus 100 may evaluate a single performance or a plurality of performances with respect to the antenna or the single RF chain simultaneously.

In operation 530, the parasitic element control apparatus 100 may adjust the parasitic element based on the control parameter. For example, in operation 530, the parasitic element control apparatus 100 may adjust the parasitic element based on the control parameter using the rule of series. Also, operation 530 may be, for example, an operation of performing switching in a group of facing parasitic elements and an independent group-to-group switching.

Depending on examples, operation 530 may be an operation of adjusting the control parameter based on a unique radiation pattern of an antenna element to change an arranged position of the parasitic element or the active element in an RF chain or a corresponding combination. For example, the parasitic element control apparatus 100 may adjust a predetermined parasitic element such that an arranged position of the parasitic element is changed to be farther from or closet to the active element. Through this, the parasitic element control apparatus 100 may allow radiation patterns of a pair of the adjusted parasitic element and another parasitic element to achieve a similarity within an allowable range. Also, the parasitic element control apparatus 100 may adjust the control parameter such that two parasitic elements having the same radiation pattern are arranged to face each other based on the active element.

When a parasitic element is added to the antenna structure, the parasitic element control apparatus 100 may adjust the parasitic elements by determining a position at which the parasitic element is to be disposed or changing an arranged position of one of the parasitic elements included in the antenna structure based on the control parameter in operation 530. That is, the parasitic element control apparatus 100 may perform adjustment by determining a position of a new parasitic element or changing a position of a parasitic element that has been arranged, based on the antenna structure.

The parasitic element control apparatus 100 may identify the radiation pattern of the antenna element by adding a beam pattern formed by a current flowing in the active element and a beam pattern formed by an induced current flowing in the parasitic element. In this example, the parasitic element control apparatus 100 may obtain a vector i of a current flowing in an antenna based on a voltage-current relationship according to Equation 3.

i=vₛ(Z+X)⁻¹u, where i=[i₀ i₁ . . . i_{N-1}]^{T} [Equation 3]
Z: impedance matrix
X: load matrix
u: unit vector

Also, the parasitic element control apparatus 100 may identify the radiation pattern based on a sum of individual patterns Pₙ(φ,θ) radiated by the antenna elements according to Equation 4.

$${P}_{total} ( φ , θ ) = {\sum }_{n = 0}^{N - 1} {P}_{n} ( φ , θ ) \qquad [ Equation 4 ]$$

The parasitic element control apparatus 100 may adjust the parasitic elements based on the identified radiation pattern. That is, the parasitic element control apparatus 100 may adjusts the parasitic elements based on the radiation pattern of each of the antenna elements. For example, the parasitic element control apparatus 100 may adjust a predetermined parasitic element such that an arranged position of the parasitic element is changed to be farther from or closet to the active element. Through this, the parasitic element control apparatus 100 may allow radiation patterns of a pair of the adjusted parasitic element and another parasitic element to achieve a similarity within an allowable range.

The parasitic element control apparatus 100 may identify the radiation pattern of each of the antenna elements by applying a current flowing in the antenna element to a unique beam pattern of the antenna element as a weight. For example, in terms of a lineal antenna array, the parasitic element control apparatus 100 may identify a radiation pattern modeled using an array factor. In this example, the parasitic element control apparatus 100 may identify a radiation pattern of an ESPAR antenna using a sum of radiation patterns formed by induced currents of parasitic elements due to an impedance load and mutual coupling and a radiation pattern formed by a current flowing in an active element. That is, the parasitic element control apparatus 100 may identify a reformed radiation pattern of the ESPAR antenna by adjusting the induced currents of the parasitic elements using an electric signal.

As such, the parasitic element control method may design a control parameter based on an antenna or RF performance, arrange parasitic elements at an optimal position, and adjust an arranged position, thereby preventing degradation in performance.

Also, the parasitic element control method may additionally perform an antenna or RF performance-based design process without need to correct a preset parameter design process.

According to an aspect, it is possible to design a control parameter based on an antenna or RF performance, arrange parasitic elements at an optimal position, and adjust an arranged position, thereby preventing degradation in performance.

According to another aspect, it is possible to additionally perform an antenna or RF performance-based design process without need to correct a preset parameter design process.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A parasitic element control apparatus for a single radio frequency (RF) chain-based antenna array, the parasitic element control apparatus comprising:
an arranger configured to arrange antenna elements, each including a single active element and a plurality of parasitic elements, and generate an antenna structure;
a designer configured to design a control parameter for controlling the parasitic elements based on the antenna structure; and
an adjuster configured to adjust the parasitic elements based on the control parameter.

2. The parasitic element control apparatus of claim 1, wherein when a radiation pattern of each of the antenna elements is identified, the designer is configured to design the control parameter based on the identified radiation pattern.

3. The parasitic element control apparatus of claim 1, further comprising:
an identifier configured to add a beam pattern formed by a current flowing in the active element and a beam pattern formed by an induced current flowing in the parasitic elements due to a mutual coupling and an impedance load, and identify the radiation pattern of each of the antenna elements,
wherein the adjuster is configured to adjust the parasitic element based on the identified radiation pattern.

4. The parasitic element control apparatus of claim 1, wherein the designer is configured to evaluate a performance for an impedance load occurring in the parasitic elements, extract an optimal combination of impedance loads satisfying a reference, and design the control parameter including information on the extracted optimal combination.

5. The parasitic element control apparatus of claim 4, wherein:
the designer is configured to set a phase or an amplitude based on the impedance load as the reference when the control parameter is designed to be associated with a multiplexing gain, and
the designer is configured to set at least one of a back-lobe, a beam width, a beam gain, and a beamforming direction based on the impedance load as the reference when the control parameter is designed to be associated with beamforming.

6. The parasitic element control apparatus of claim 1, wherein the arranger is configured to arrange the parasitic elements by arranging a pair of parasitic elements based on the active element.

7. The parasitic element control apparatus of claim 1, wherein when the control parameter is associated with a change in arranged position, the adjuster is configured to adjust the parasitic elements by switching parasitic elements facing each other based on the active element.

8. The parasitic element control apparatus of claim 1, wherein when a parasitic element is added to the antenna structure, the adjuster is configured to adjust the parasitic elements by determining a position at which the parasitic element is to be disposed in the antenna structure or changing a position of one of the parasitic elements included in the antenna structure, based on the control parameter.

9. A method of controlling a parasitic element for a single radio frequency (RF) chain-based antenna array, the method comprising:
arranging antenna elements, each including a single active element and a plurality of parasitic elements, and generating an antenna structure;
designing a control parameter for controlling the parasitic elements based on the antenna structure; and
adjusting the parasitic elements based on the control parameter.

10. The method of claim 9, further comprising:
designing, when a radiation pattern of each of the antenna elements is identified, the control parameter based on the identified radiation pattern.

11. The method of claim 9, further comprising:
adding a beam pattern formed by a current flowing in the active element and a beam pattern formed by an induced current flowing in the parasitic elements due to a mutual coupling and an impedance load, and identifying the radiation pattern of each of the antenna elements; and
adjusting the parasitic element based on the identified radiation pattern.

12. The method of claim 9, wherein the designing includes:
evaluating a performance for an impedance load occurring in the parasitic elements and extracting an optimal combination of impedance loads satisfying a reference; and
designing the control parameter including information on the extracted optimal combination.

13. The method of claim 12, wherein the designing further includes:
setting a phase or an amplitude based on the impedance load as the reference when the control parameter is designed to be associated with a multiplexing gain; and
setting at least one of a back-lobe, a beam width, a beam gain, and a beamforming direction based on the impedance load as the reference when the control parameter is designed to be associated with beamforming.

14. The method of claim 9, wherein the arranging includes arranging the parasitic elements by arrange a pair of parasitic elements based on the active element.

15. The method of claim 9, wherein the adjusting includes adjusting the parasitic elements by switching parasitic elements facing each other based on the active element.

16. The method of claim 9, wherein when a parasitic element is added to the antenna structure, the adjusting further includes:
adjusting the parasitic elements by determining a position at which the parasitic element is to be disposed in the antenna structure based on the control parameter; or
changing a position of one of the parasitic elements included in the antenna structure, based on the control parameter.
